(19) United States
(12) Patent Application Publication
(10) Pub. No.: US 2007/0201798 A1
(43) Pub. Date: Aug. 30, 2007

(54) Hybrid adapter

(75) Inventors: Anne Kramer, Berlin (DE); Hans-Joachim Faika, Berlin (DE); Jorg Adomeit, Berlin (DE)

Correspondence Address: Attention of Steven C. Bruess;MERCHANT & GOULD P.C., P.O. Box 2903, Minneapolis, MN, 55402-0903, US

(73) Assignee: ADC GmbH, Berlin (DE)

(21) Appl. No.: 11/789,896

(22) Filed: Apr. 26, 2007

Related U.S. Application Data
(63) Continuation of application No. 11/251,009, filed on Oct. 11, 2005.

(51) Int. Cl. G02B 6/38

(52) U.S. Cl. 385/75; 385/55; 385/58; 385/60; 385/69; 385/70; 385/72

(57) ABSTRACT

A universal hybrid adapter includes a first housing part, a second housing part, and a sleeve. The first housing part has a receptacle end configured to receive a plug connector including a ferrule having a first diameter. The second housing part has a receptacle end configured to receive a plug connector including a ferrule having a second diameter different from the first diameter. A first end of the sleeve is configured to receive the ferrule having the first diameter and a second end of the sleeve is configured to receive the ferrule having the second diameter. The transition from the first end to the second end of the sleeve takes place at right angles.

### CROSS REFERENCE TO RELATED APPLICATION

This application is a continuation of application Ser. No. 11/251,009, filed Oct. 11, 2005, which application is incorporated herein by reference.

### TECHNICAL FIELD

The invention relates to a hybrid adapter for fiberglass plug connectors.

### BACKGROUND

Known fiberglass plug connectors can be split into two groups, namely standard connectors having a ferrule diameter of 2.5 mm and small form factor connectors having a ferrule diameter of 1.25 mm. In this case, there are different types in each group. Standard connectors are, for example, plug connectors of the type ST, FC or SC. Small form factor connectors are, for example, the types LX.5, LC or MU.

The term adapter is in this case used when two different types in one group are intended to be connected to one another, whereas hybrid adapters connect plug connectors from different groups.

U.S. Pat. No. 5,274,729 discloses an adapter for standard connectors by means of which the different types ST, FC and SC can be connected to one another.

DE 101 41 449 A1 discloses a universal adapter for the group of small form factor connectors. In this case, an embodiment is disclosed in which the adapter is composed of two symmetrical housing halves which each define a receptacle for a plug connector. In this case, the housing halves are designed such that they are each suitable for receiving all of the three types LX.5, LC or MU. In the interior of the housing halves is arranged a sleeve which receives the ferrules of the two plug connectors to be connected. LX.5 plug connectors have a ferrule which protrudes from the housing of the plug connector and is shorter than that for LC or MU plug connectors, with the result that the housing half is formed with a pin which, during an insertion procedure, moves a laser light flap away such that the ferrule is not damaged. DE 699 06 230 T2 discloses a hybrid adapter, by means of which it is possible to receive plug connectors from different groups. The hybrid adapter comprises an alignment sleeve for axially aligning ferrules, having a support element which defines an essentially central hole through said support element, the hole comprising a first section and a second section. The first and the second section are aligned in the longitudinal direction and are located close to one another, the inner surface of the hole tapering increasingly at a predetermined angle of less than approximately 5 degrees. The support element comprises a first inner wall which at least partially defines the first section, the first inner wall comprising a plurality of first contact points which are spaced apart from one another symmetrically over the first inner wall, the first contact points being dimensioned in order to receive a first ferrule of a first diameter which has no tapering. The support element comprises a second inner wall which at least partially defines the second section, the second inner wall comprising a plurality of second contact points which are spaced apart from one another symmetrically over the second inner wall, the second contact points being dimensioned in order to receive a second ferrule of a second diameter which is not the same as the first diameter and likewise has no tapering.

One disadvantage of the known hybrid adapter is the fact that it is not suitable for receiving LX.5 plug connectors.

### SUMMARY

The invention is therefore based on the technical problem of providing a universal hybrid adapter and a sleeve suitable therefore, by means of which it is also possible to connect LX.5 plug connectors to standard connectors.

For this purpose, the sleeve is of stepped design. The transition from the first diameter to the second diameter takes place at a right-angle. The sleeve has an axially continuous slot. The right-angled transition ensures that it is possible for the ferrule having the smaller diameter to be inserted at least up to the transition, but preferably even as far as into the region of the larger diameter. Even in the case of short ferrules of LX.5 plug connectors, this ensures that the ferrules can be brought together edge to edge. Owing to the continuous slot, it is in this case possible for the sleeve to compensate for manufacturing tolerances of the sleeve itself and of the ferrules. Since the ferrules can be reliably brought together edge to edge, they may have both a UPC (Ultra Polishing Contact) ground surface and an APC (Angle Polishing Contact) ground surface. The former is a planar-parallel ground surface, and the latter is a ground surface at an angle of 8° or 9° in order to deflect reflections at the coupling point.

In one preferred embodiment, the length of the section of the sleeve having the first smaller diameter is smaller than the length having the larger diameter. This increasingly ensures that the ferrule having the smaller diameter is inserted in the region of the sleeve having the larger diameter, with the result that better contact is made. The ratio is preferably at least 2:3, further preferably the ratio being selected to be in the region of 1:3.

Further preferably, the sleeve is made of ceramic, bronze or plastic, ceramic being particularly preferred.

In one further preferred embodiment, the first housing part is formed with an integrated laser protection flap, whose preferably spring-loaded flap is automatically pushed against the housing wall without coming into contact with the ferrule when a plug connector is inserted.

In one further preferred embodiment, the first housing part is in the form of a universal adapter for small form factor connectors, reference being made as regards a preferred embodiment to DE 101 41 449 A1, express reference hereby being made to said disclosure.

In this case, a housing half of the adapter described there is thus used as the universal interface for the small form factor connectors.

In one further preferred embodiment, the second housing part has an opening for the purpose of receiving FC and ST plug connectors, it being possible for an FC or ST interface, which is preferably made of metal, to be inserted in said opening.

In one further preferred embodiment, the FC or ST interface is provided with a radial groove, into which a sprung, forked metal sheet can be plugged on from the front side of a front panel. By this means, the interface can be selected to be very short, and the adapter can be detached simply and rapidly from the front side.

In one further preferred embodiment, the second housing part has a separate sleeve receptacle for the purpose of receiving an SC plug connector, it being possible for said sleeve receptacle to be latched to the first and second housing parts.

In one further preferred embodiment, a front frame having an integrated laser protection flap is latched onto the second housing part.

The second housing part for the SC plug connector is preferably fixed to a front panel by means of two lateral spring clips.

### BRIEF DESCRIPTION OF THE DRAWINGS

The invention will be explained in more detail below with reference to a preferred exemplary embodiment. In the figures:

FIG. 1 shows a perspective illustration of the sleeve,

FIG. 2 shows an exploded illustration of a universal hybrid adapter for receiving an FC plug connector,

FIG. 3 shows an exploded illustration of the universal hybrid adapter for receiving an ST plug connector,

FIG. 4 shows an exploded illustration of the universal hybrid adapter for receiving an SC plug connector,

FIG. 5 shows a universal hybrid adapter for receiving an FC plug connector when assembled,

FIG. 6 shows a universal hybrid adapter for receiving an SC plug connector when assembled,

FIG. 7 shows a universal hybrid adapter for receiving an ST plug connector when assembled, and

FIG. 8 shows a sectional illustration through the adapter shown in FIG. 7.

### DETAILED DESCRIPTION

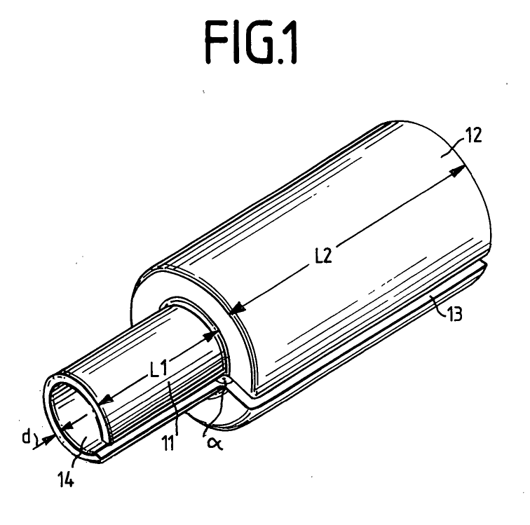

FIG. 1 shows a sleeve 10 for receiving ferrules having different diameters. The sleeve 10 in this case has two cylindrical sections 11 and 12, the transition between the two sections 11, 12 taking place in a stepped manner at a right angle α. The thickness d of the sleeve 10 is in this case constant in both sections 11, 12. Furthermore, the sleeve 10 has an axially continuous slot 13. The length L1 of the first section 11 is in this case smaller than the length L2 of the second section 12. The end face 14 in this case has an opening for a ferrule having a small diameter, and the opposite end face (not visible) has an opening for a ferrule having a larger diameter.

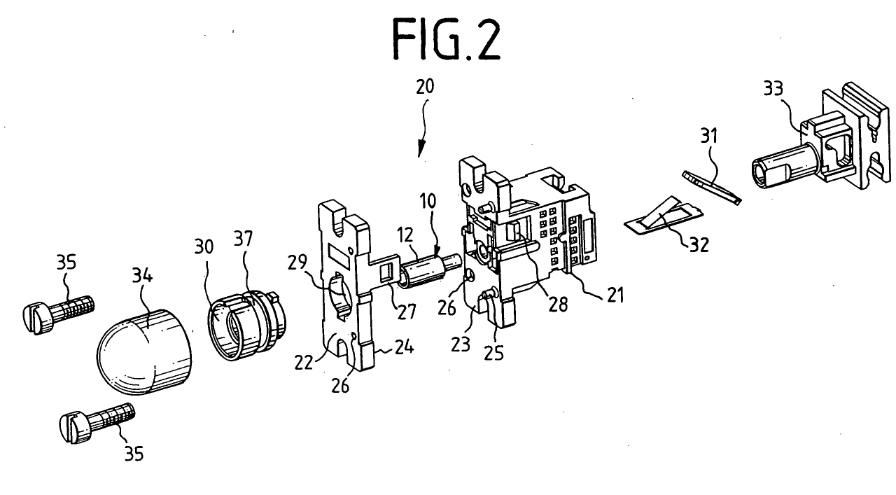

FIG. 2 shows an exploded illustration of a universal hybrid adapter 20 for an FC plug connector. The universal hybrid adapter 20 comprises a first housing part 21, which is designed such that it can receive all known small form factor connectors LX.5, LC or MU plug connectors. Furthermore, the universal hybrid adapter 20 comprises a second housing part 22. The first and second housing parts 21, 22 each have a flange 23, 24, on which are arranged latching pins 25 or latching holes 26, the latching pins 25 of one flange corresponding to the latching holes 26 of the other flange, and vice versa. Furthermore, the second housing part 22 has two latching brackets 27 which latch into a respective latching recess 28 in the first housing part 21. By means of the latching pins 25, latching holes 26, latching brackets 27 and latching recesses 28, the two housing parts 21, 22 can be latched fixedly to one another, the sleeve 10 being shown between the two housing parts 21, 22 and being guided, when assembled, in the first housing part 21. The second housing part 22 has an opening 29, through which the region 12 of the sleeve 10 protrudes. On the other side of the housing part 22 is arranged an FC interface 30 which is inserted through the opening 29 and receives the region 12 of the sleeve 10. The first housing part 21 is formed with an integrated laser protection flap 31 which is loaded with a spring 32. Furthermore, a dust protection cap 33 for the first housing part 21 and a dust protection cap 34 for the second housing part 22 are illustrated in FIG. 2. The dust protection caps 33, 34 in this case are only used if no plug connector is inserted in the adapter 20. Furthermore, two fixing screws 35 are illustrated, by means of which the universal hybrid adapter 20 is screwed to a front panel (not shown), the fixing screws 35 being passed through the arched depressions on the upper and lower ends of the flanges 23, 24. The assembled state without dust protection caps is shown in FIG. 5, a sprung, forked metal sheet 36 being used instead of the fixing screws 35 for fixing it to a front panel and being pushed into a groove 37 (see FIG. 2) and fixedly clamping the universal hybrid adapter 20 to the front panel (not shown). The front panel is in this case located between the forked metal sheet 36 and the second housing part 22.

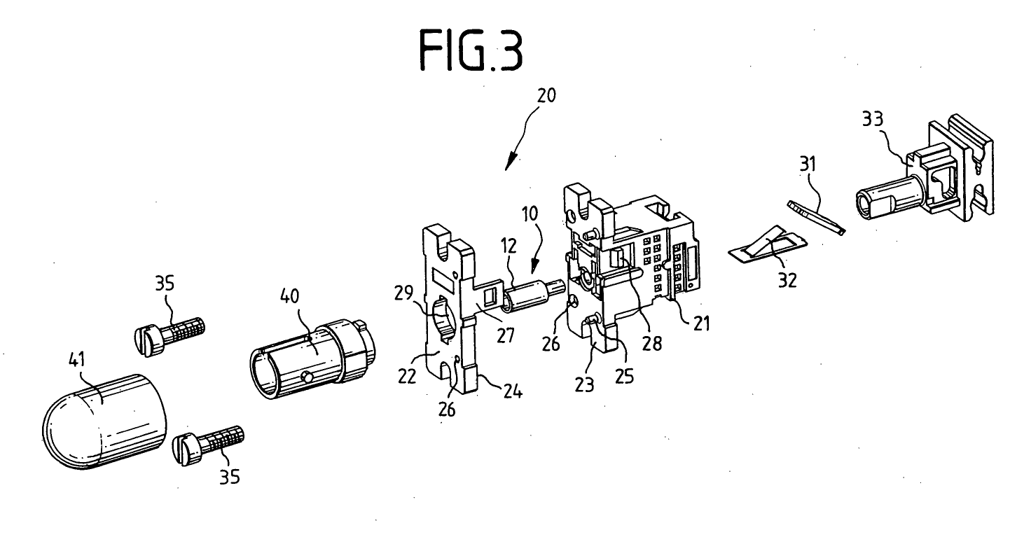

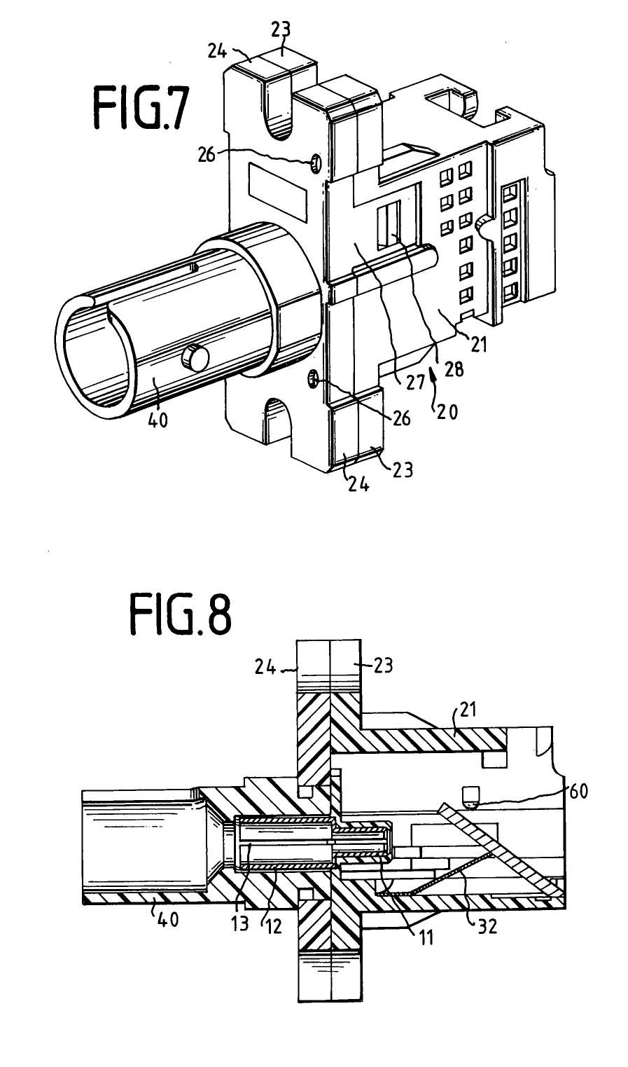

FIG. 3 shows an exploded illustration of the universal hybrid adapter 20 for an ST plug connector, identical components to those in FIG. 2 being provided with the same reference numerals. The only difference from the FC plug connector is the ST interface 40 and the dust protection cap 41 which is matched to the geometry of the ST interface 40. Otherwise, reference may be made in full to the explanations for FIG. 2. The ST interface 40 may in this case, like the FC interface 30, be formed with a groove for receiving a sprung, forked metal sheet. The assembled universal hybrid adapter 20 having an ST interface 40 is shown in FIG. 7.

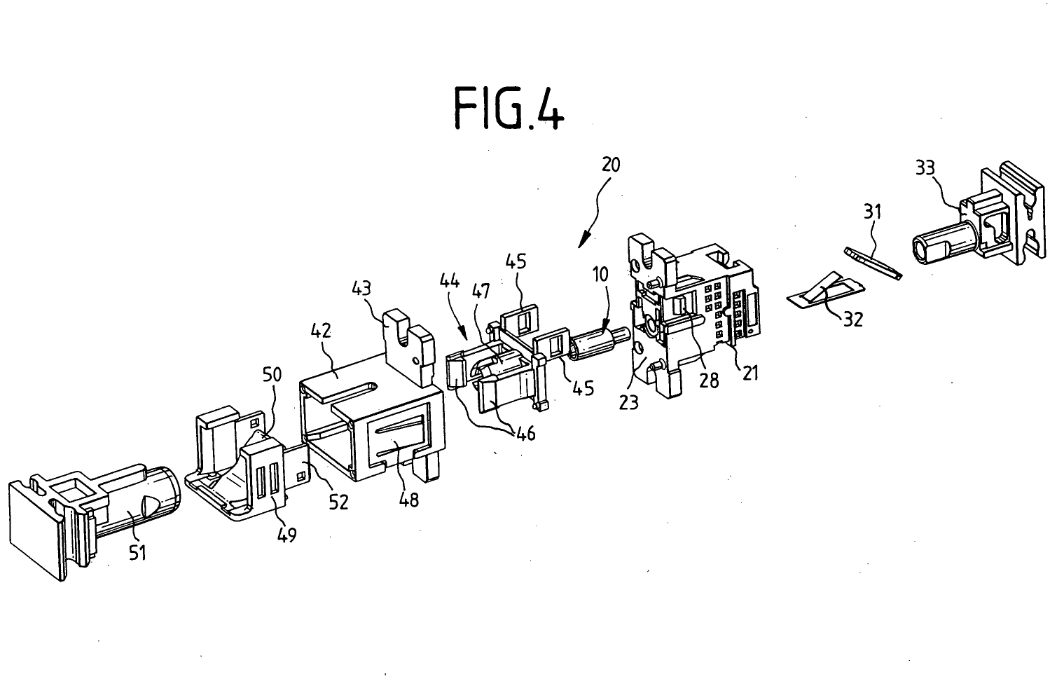

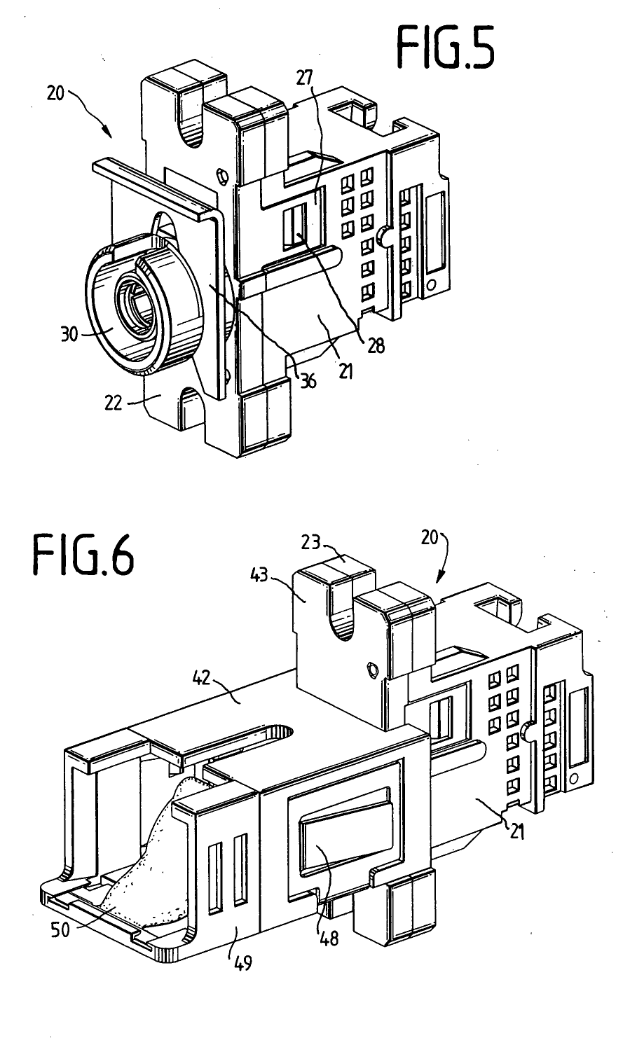

FIG. 4 then shows an exploded illustration of the universal hybrid adapter 20 for receiving SC plug connectors. In this case, the right-hand part including the sleeve 10 corresponds to the preceding exemplary embodiments. The second housing part 42, however, is in the form of a square having flanges 43. In this case, the flanges 23 and 43 are fixed in a similar manner to in the preceding embodiments. Owing to the shape of the second housing part 42, there would be no guidance for the sleeve 10. A separate sleeve receptacle 44 is thus provided. The sleeve receptacle 44 is formed with two latching brackets 45 which latch into inner latching recesses in the first housing part 21 and two latching brackets 46 which latch into the second housing part 42. Furthermore, the sleeve receptacle 44 has a cylindrical attachment 47, in which the section 12 of the sleeve 10 is guided. Arranged on the sides of the second housing part 42 are spring clips 48, by means of which the universal hybrid adapter 20 can be fixed to a front panel. Latched onto the front side of the second housing part 42 is a front frame 49 having an integrated laser flap 50. Furthermore, a dust protection cap 51 is illustrated. For latching purposes, the front frame 49 is formed with two latching brackets 52. The assembled state is in this case illustrated in FIG. 6.

FIG. 8 shows a sectional illustration of the universal hybrid adapter 20 shown in FIG. 7. In this case, it is particularly easy to recognize the right-angled transition between the sections 11 and 12 of the sleeve 10. Furthermore, a flap pin 60 can be seen which serves the purpose of opening the laser protection flap 31 when an LX.5 plug connector is inserted.

### List of Reference Numerals

10 sleeve

11 cylindrical section

12 cylindrical section

13 slot

14 end face

20 universal hybrid adapter

21 first housing part

22 second housing part

23 flange

24 flange

25 latching pins

26 latching holes

27 latching bracket

28 latching recess

29 opening

30 FC interface

31 laser protection flap

32 spring

33 dust protection cap

34 dust protection cap

35 fixing screws

36 forked metal sheet

37 groove

40 ST interface

41 dust protection cap

42 second housing part

43 flange

44 sleeve receptacle

45 latching bracket

46 latching bracket

47 cylindrical attachment

48 spring clips

49 front frame

50 laser flap

51 dust protection cap

52 latching bracket

60 flap pin

L1 length

L2 length

d thickness

∀ right angle

1. A universal hybrid adapter, comprising:
a first housing part having a first end and an opposite second end, the first end of the first housing part defining a first plug receptacle, the first plug receptacle configured to receive a first plug connector having a first ferrule having a diameter, the second end of the first housing part defining a sleeve receptacle;
a second housing part having a first end and an opposite second end, the first end of the second housing part defining a sleeve receptacle, the second end of the second housing part defining a second plug receptacle, the second plug receptacle being configured to receive a second plug connector having a second ferrule having a diameter, the diameter of the second ferrule being different than the diameter of the first ferrule; and
a sleeve, the sleeve including a first portion having a first diameter and a second portion having a second diameter, the first diameter of the first portion being different from the second diameter of the second portion, the first portion of the sleeve being received directly in the sleeve receptacle of the first housing part, the second portion of the sleeve being received directly in the sleeve receptacle of the second housing part.

2. The universal hybrid adapter of claim 1, wherein the second plug receptacle is configured to receive FC and ST plug connectors.

3. The universal hybrid adapter of claim 1, wherein the first portion of the sleeve transitions into the second portion at a right angle.

4. The universal hybrid adapter of claim 1, wherein the sleeve defines an axially continuous slot.

5. The universal hybrid adapter of claim 1, wherein the sleeve is made of at least one of the group consisting of ceramic, bronze, and plastic.

6. The universal hybrid adapter of claim 1, wherein a ratio of a length of the first portion of the sleeve to a length of the second portion of the sleeve is at least 2:3.
